(19) United States
(12) Patent Application Publication
(10) Pub. No.: US 2005/0076116 A1
(43) Pub. Date: Apr. 7, 2005

(54) Information server performance alert system and method

(75) Inventor: Jimy Liu, Hsin-Chu (TW)

Correspondence Address: TUNG & ASSOCIATES, Suite 120, 838 W. Long Lake Road, Bloomfield Hills, MI, 48302, US

(73) Assignee: Taiwan Semiconductor Manufacturing Co., Ltd.

(21) Appl. No.: 10/671,021

(22) Filed: Sep. 24, 2003

(51) Int. Cl. G06F 15/173

(52) U.S. Cl. 709/224

(57) ABSTRACT

An information server system and an information server method each comprise a software utility associated with an information server. The information server is suitable for connection to a communications network and capable of servicing an information request. The software utility is configured to: (1) measure a performance parameter value for fulfillment of the information request; and (2) issue an alert to an information server administrator if the measured performance parameter value exceeds a specified range.

### BACKGROUND OF THE INVENTION

1. Field of the Invention

The present invention relates to systems and methods for controlling information server performance. More particularly, the present invention relates to systems and methods for efficiently controlling information server performance.

2. Description of the Related Art

The Internet is a computer based worldwide communications network that provides for efficient communications between parties. The World Wide Web is a computer based information network that may be accessed through the Internet. It comprises a multitude of information server computers containing defined information resources. The information resources are catalogued through use of uniform resource locator (URL) designators. The Internet and the World Wide Web provide a powerful combination for location and access of vast quantities of information.

Although access of information through the Internet and the World Wide Web is particularly convenient and efficient, problems nonetheless exist. As Internet and World Wide Web user traffic volumes increase, system performance and response time often suffer. It is desirable to provide systems and methods for efficient Internet and World Wide Web communications and information access.

The present invention is directed towards the foregoing goal.

Various communication systems and methods having desirable properties have been disclosed within the network communications arts.

Included but not limited are systems and methods disclosed within: (1) DeBettencourt et al., in U.S. Patent Pub. No. 2002/0042823 (a system which manages a plurality of Web servers); (2) Boyer et al., in U.S. Pat. No. 6,381,635 (a method for displaying multiple performance measurements of a Web site); and (3) Glommen et al., in U.S. Pat. No. 6,393,479 (a system for analyzing traffic through a Web site in real-time).

The teachings of the foregoing disclosures are incorporated herein fully by reference.

Additional systems and methods are desirable for efficient Internet and World Wide Web communications and information access.

The present invention is directed towards that goal.

### SUMMARY OF THE INVENTION

A first object of the invention is to provide a system and a method for Internet and World Wide Web communications and information access.

A second object of the invention is to provide a system and a method in accord with the first object of the invention, where the system and method are efficient.

In accord with the objects of the invention, the invention provides an information server system, a method for operating the information server system and a software utility employed within the system and the method.

In accord with the invention, the information server system comprises an information server suitable for connection to a communications network and capable of servicing an information request. The information server system also comprises a software utility associated with the information server. The software utility is configured to: (1) measure a performance parameter value for fulfillment of the information request; and (2) issue an alert to an information server administrator if the measured performance parameter value exceeds a specified range.

The system in accord with the invention contemplates the method and the software utility in accord with the invention.

The invention provides a system and a method for efficient Internet and World Wide Web communications and information access.

The invention realizes the foregoing object by employing a software utility associated with an information server. The information server is suitable for connection to a communications network and capable of servicing an information request. The software utility is configured to: (1) periodically measure a performance parameter value for fulfillment of the information request; and (2) issue an alert to a server administrator if the measured performance parameter value is not within a specified range.

### BRIEF DESCRIPTION OF THE DRAWINGS

The objects, features and advantages of the invention are understood within the context of the Description of the Preferred Embodiment, as set forth below. The Description of the Preferred Embodiment is understood within the context of the accompanying drawings, which form a material part of this disclosure, wherein:

FIG. 1 shows a schematic diagram of an information server system in accord with the invention.

FIG. 2 shows a series of configuration files which may be employed within the information server system of the invention.

### DESCRIPTION OF THE PREFERRED EMBODIMENT

The invention provides a system and a method for efficient Internet and World Wide Web communications and information access.

The invention realizes the foregoing object by employing a software utility associated with an information server. The information server is suitable for connection to a communications network and capable of servicing an information request. The software utility is configured to: (1) periodically measure a performance parameter value for fulfillment of the information request; and (2) issue an alert to a system administrator if the measured performance parameter value exceeds a specified range.

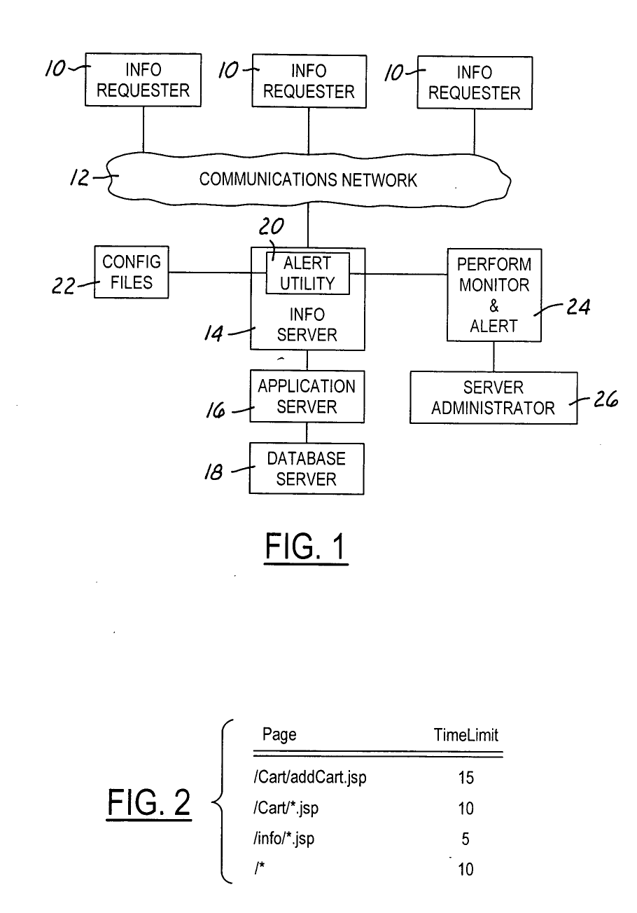

FIG. 1 shows a schematic diagram of an information server system in accord with the invention.

Within FIG. 1, a series of information requesters 10 is connected to a communications network 12. The requesters 10, and their connections to the communications network 12, are otherwise generally conventional. The requesters 10 may request information for personal or commercial use. The communications network 12 is typically an Internet communications network. Other communications networks, such as but not limited to intranet, local area network (LAN) and wide area network (WAN) communications networks, may also be employed. Typically, the information requesters 10 are connected to the communications network 12 through network service suppliers which are not specifically illustrated. The network service suppliers (i.e., Internet service providers (ISPs)) are also generally conventional.

An information server 14 is also connected to the communications network 12. In turn, an application server 16 is connected to the information server 14, and a database server 18 is connected to the application server 16. Each of the information server 14, the application server 16 and the database server 18 is otherwise generally conventional with respect to both hardware components and software components.

When operating the information server system of FIG. 1, a requester 10 issues an information request which reaches the information server 14 through the communications network 12. The information server 14 forwards the information request to the application server 16. In turn, the application server 16 forwards the information request to the database server 18 which fulfills the information request through access of information within a database (not specifically illustrated) controlled by the database server 18. The requested information when located by the database server 18 is forwarded back to the requester 10 through the information server 14 and the communications network 12.

When the communications network 12 is an Internet communications network and the information server 14 is intended as a component of the World Wide Web, information requesters 10 will typically code information requests as uniform resource locators (URLs). The uniform resource locators will generally define a specific information page within a database controlled by the database server 18. Uniform resource locators may be coded directly by an information requester 10. Alternatively, a uniform resource locator may be intrinsically coded with a hypertext link.

The invention provides an alert utility 20 in conjunction with the information server 14. The alert utility 20 is a software utility which is intended to be either contained within, adjunct to or otherwise associated with the information server 14. The invention contemplates no additional hardware or software components interposed between the information server 14 and the alert utility 20.

The alert utility 20 operates with input from at least one configuration file 22. The alert utility 20 is intended to measure a performance parameter value of an information request received by and subsequently fulfilled by the information server 14. Typically, the performance parameter is an aggregate response time of the information server 14 the application server 16 and the database server 18 (in addition to other intervening or extending components) when fulfilling the information request. Other performance parameters may also be employed. Thus, the alert utility 20 provides for both: (1) a log-in time of an information request when received from a requester 10 by the information server 14; and (2) a log-out time of the requested information when the requested information is forwarded to the requester 10 from the information server 14. Therefore, the performance parameter is directed at least in part towards information server 14, application server 16, database server 18 and database access performance, and not to communications network 12 performance.

FIG. 2 illustrates a series of configuration files in accord with the invention. The series of files lists individual information request pages (by URL) and their associated response time limit performance goals. The information request pages are provided as Java(tm) script pages, but the invention is not intended to be so limited. Response time limit goals are arbitrarily determined. Other information may also be included within the configuration files, such as contact information for server administrator alert as discussed below.

Finally, the alert utility 20 provides for a performance monitoring and alert 24 to a server administrator 26. The alert is provided when an information request performance does not achieve a pre-determined performance (i.e., response time) goal. The performance monitoring may include routine cataloguing of requested information, query strings, and response times within a database.

The invention contemplates that the server administrator is a person. The server administrator once alerted may effect information server system resource allocations to provide return of measured performance parameter values to objectives (i.e., reduction of response time). The performance alert may be provided as an e-mail alert, a telecommunications paging alert or a telecommunications voice mail alert.

The alert utility may be implemented employing any of several software products. While not limiting the invention, Netscape(tm) application interface software is particularly suitable for the invention. Specific programming steps are within ordinary skill in the art.

The preferred embodiment of the invention is illustrative of the invention rather than limiting of the invention. Revisions and modifications may be made to components in accord with the preferred embodiment of the invention, while still providing a system and a method in accord with the invention, further in accord with the accompanying claims.

1. An information server system comprising:
an information server suitable for connection to a communications network and capable of servicing an information request; and
a software utility associated with the information server, where the software utility is configured to:
measure a performance parameter value for fulfillment of the information request; and
issue an alert to an information server administrator if the measured performance parameter value exceeds a specified range.

2. The system of claim 1 wherein the communications network is an Internet communications network.

3. The system of claim 1 wherein the information server is part of the World Wide Web.

4. The system of claim 1 wherein the performance parameter is a response time.

5. The system of claim 1 wherein the information server administrator is a person.

6. The system of claim 5 wherein the alert is an e-mail alert.

7. The system of claim 5 wherein the alert is a telecommunications alert.

8. A method for operating an information server comprising:
providing an information server connected to a communications network and capable of servicing an information request, where the information server has associated therewith a software configured to:
measure a performance parameter value for fulfillment of the information request; and
issue an alert to an information server administrator if the measured performance parameter value exceeds a specified range;
issuing an information request to the information server, fulfilling the information request through the information server and determining the measured performance parameter value; and
alerting the information server administrator if the measured performance parameter value exceeds the specified range.

9. The method of claim 1 wherein the communications network is an Internet communications network.

10. The method of claim 1 wherein the information server is part of the World Wide Web.

11. The method of claim 1 wherein the performance parameter is a response time.

12. The method of claim 1 wherein the information server administrator is a person.

13. The method of claim 12 wherein the alert is an e-mail alert.

14. The method of claim 12 wherein the alert is a telecommunications alert.

15. A software product comprising:
a tangible medium having coded therein a series of machine instructions which provide for:
measurement of a performance parameter value for fulfillment of an information request to an information server suitable for connection to a communications network; and
issuance of an alert to an information server administrator if the measured performance parameter value exceeds a specified range.

16. The product of claim 1 wherein the communications network is an Internet communications network.

17. The product of claim 1 wherein the information server is part of the World Wide Web.

18. The product of claim 1 wherein the performance parameter is a response time.

19. The product of claim 5 wherein the alert is an e-mail alert.

20. The product of claim 5 wherein the alert is a telecommunications alert.
